(19) United States
(12) Patent Application Publication
(10) Pub. No.: US 2014/0107851 A1
(43) Pub. Date: Apr. 17, 2014

(54) APPARATUS AND METHOD FOR EVALUATING ENERGY CONSUMPTION PERFORMANCE OF BUILDING

(71) Applicant: ELECTRONICS AND TELECOMMUNICATIONS RESEARCH INSTITUTE, Daejeon (KR)

(72) Inventors: Hyun Jin YOON, Daejeon (KR); Youn Kwae JEONG, Daejeon (KR); Il Woo LEE, Daejeon (KR)

(73) Assignee: ELECTRONICS AND TELECOMMUNICATIONS RESEARCH INSTITUTE, Daejeon (KR)

(21) Appl. No.: 13/954,004

(22) Filed: Jul. 30, 2013

(30) Foreign Application Priority Data
Oct. 16, 2012 (KR) 10-2012-0114553

(51) Int. Cl. G06Q 50/06

(52) U.S. Cl. CPC G06Q 50/06
USPC 700/291

(57) ABSTRACT

Disclosed are an apparatus and a method for evaluating energy consumption performance of a building according to an operation scheme of a existing building by predicting a reference energy consumption amount based on a building operation condition required for an operation process of the existing building and by comparing the predicted reference energy consumption amount with an actual energy consumption amount.

### CROSS-REFERENCE TO RELATED APPLICATIONS

This application claims priority to and the benefit of Korean Patent Application No. 10-2012-0114553 filed in the Korean Intellectual Property Office on Oct. 16, 2012, the entire contents of which are incorporated herein by reference.

### TECHNICAL FIELD

The present invention relates to a building energy performance evaluating system, and more particularly, to an apparatus and a method for evaluating energy consumption performance of a building according to an operation scheme of an existing building by predicting a reference energy consumption amount according to a building operation condition based on energy consumption information, building operation information, and building plan information obtained during an operation process of the existing building and by comparing the predicted reference energy consumption amount with an actual energy consumption amount.

### BACKGROUND ART

An existing building energy performance evaluating method provides evaluation according to a plan scheme of predicting performance indices, such as a required energy amount of a building, an energy consumption amount, CO2 emission, and the like, based on plan data such as building facade, air conditioning and heating, refrigerating, illumination, electricity, a standard of new regeneration equipment, and the like.

However, although a building is based on a predetermined performance during a planning stage, actual energy consumption may significantly differ based on an environment in which the building is operated, such as a facility operation and maintenance, a building operation scheme, a behavior of an occupant, and the like. Accordingly, it is difficult to exactly evaluate energy performance according to an actual building operation using a plan data based evaluation method using an existing standard operation profile.

Meanwhile, there is a method of evaluating building energy performance according to an actual operation scheme using an energy simulation tool such as EnergyPlus capable of performing complex energy analysis, ESP-R, and TRNSYS. However, there is an issue in that an energy analysis model needs to be individually generated for each target building. Such method is an evaluation method that requires a high level of proficiency and a large amount of time and costs. Accordingly, there is a need for an evaluation method that is effective in terms of costs and may be readily used, and an automation tool.

### SUMMARY OF THE INVENTION

The present invention has been made in an effort to provide an apparatus and a method for evaluating energy consumption performance of a building by predicting a reference energy consumption amount according to a building operation condition based on energy consumption information, building plan information, and building operation information of an existing building in operation and by comparing the predicted reference energy consumption amount with an actual energy consumption amount.

An exemplary embodiment of the present invention provides an apparatus for evaluating energy consumption performance of a building, the apparatus including: a data input unit configured to receive building plan information, building operation information, and energy consumption information about at least one building; an evaluation managing unit configured to generate a reference energy consumption amount prediction model regarding the building based on the building plan information, the building operation information, and the energy consumption information that are transferred from the data input unit; an evaluation performing unit configured to determine energy consumption performance of a target building based on a comparison result with an actual energy consumption amount based on the reference energy consumption amount prediction model, using building plan information, building operation information, and energy consumption information about the target building of which energy consumption performance is to be evaluated; a storage unit configured to store an evaluation result in which the building plan information, the building operation information, the energy consumption information, the reference energy consumption amount prediction model, and the energy consumption performance are determined; and a display unit configured to provide the stored evaluation result to a user.

The evaluation managing unit may select the at least one building as a standard building and predict an energy consumption amount from building plan information and building operation information of the standard building.

The evaluation managing unit may further include a standard building managing unit configured to classify the at least one building based on a building use, and to generate and manage a standard building list for each building use by selecting the standard building from the classified buildings based on the building use.

The evaluation managing unit may further include a reference energy consumption amount prediction model managing unit configured to generate and manage the reference energy consumption amount prediction model, and the reference energy consumption amount prediction model may be defined as an equation model of energy consumption amount prediction that includes, as an independent variable from building plan information and building operation information of a building belonging to the standard building list, a building operation condition having a high correlation with an actual energy consumption amount of a building in operation, and includes, as a dependent variable from energy consumption information of the building, a value obtained by calculating a first energy consumption amount per annual unit area.

The evaluation managing unit may induce a coefficient of the reference energy consumption amount prediction model using building plan information, building operation information, and energy consumption information of the building belonging to the standard building list, and may generate at least one reference energy consumption amount prediction model for each building use based on the building use.

The evaluation managing unit may further include: a building plan information managing unit configured to manage at least one of construction plan information, facility standard information, and facility control scheme information as the building plan information; a building operation information managing unit configured to manage building operation information in which an operation characteristic of the building is reflected; and an energy consumption information managing unit configured to manage energy consumption information that includes a monthly energy consumption amount based from at least previous one year.

The evaluation performing unit may calculate a prediction value of a reference energy consumption amount-using the reference energy consumption amount prediction model, based on a building operation condition of the target building of which energy consumption performance is to be evaluated, and may evaluate the energy consumption performance through benchmarking with consumption performance of another building by comparing the prediction value with the actual energy consumption amount calculated from energy consumption amount information.

The evaluation performing unit may further include a reference energy consumption amount predicting unit configured to predict a first energy consumption amount per annual unit area by calculating a building operation condition corresponding to an independent variable of the reference energy consumption amount prediction model from building plan information, building operation information, and energy consumption information of the target building, and by replacing the calculated building operation condition for the reference energy consumption amount prediction model regarding the building use of the target building.

The evaluation performing unit may further include: a current energy consumption amount calculating unit configured to calculate the first energy consumption amount per annual unit area from actual energy consumption information of the target building; an energy consumption performance analyzing unit configured to compare a reference energy consumption amount predicted by the reference energy consumption amount predicting unit with an actual energy consumption amount calculated by the current energy consumption amount calculating unit, and to compare an energy consumption performance level of the target building with an energy consumption performance level of another building having a similar building use and operation condition and thereby evaluate the energy consumption performance of the target building; and an evaluation performance result managing unit configured to manage the actual energy consumption amount, the reference energy consumption amount, and the comparison and evaluation.

Another exemplary embodiment of the present invention provides a method of evaluating energy consumption performance of a building, the method including: a data input operation of receiving building plan information, building operation information, and energy consumption information about at least one building; an evaluation managing operation of generating a reference energy consumption amount prediction model regarding the building based on the building plan information, the building operation information, and the energy consumption information that are transferred in the data input operation; an evaluation performing operation of determining energy consumption performance of a target building based on a comparison result with an actual energy consumption amount based on the reference energy consumption amount prediction model, using building plan information, building operation information, and energy consumption information about the target building of which energy consumption performance is to be evaluated; a storage operation of storing an evaluation result in which the building plan information, the building operation information, the energy consumption information, the reference energy consumption amount prediction model, and the energy consumption performance are determined; and a display operation of providing the stored evaluation result to a user.

The evaluation managing operation may further include: a classifying operation of classifying the at least one building based on a building use; and a standard building managing operation of generating and managing a standard building list for each building use by selecting a standard building from the classified buildings based on the building use.

The evaluation managing operation may further include a reference energy consumption amount prediction model managing operation of generating and managing the reference energy consumption amount prediction model, and the reference energy consumption amount prediction model may be defined as an equation model of energy consumption amount prediction that includes, as an independent variable from building plan information and building operation information of the building belonging to the standard building list, a building operation condition having a high correlation with an actual energy consumption amount of a building in operation, and includes, as a dependent variable from energy consumption information of the building, a value obtained by calculating a first energy consumption amount per annual unit area.

The evaluation performing operation may further include: a reference energy consumption amount predicting operation of calculating a prediction value of a reference energy consumption amount using the reference energy consumption amount prediction model based on a building operation condition of the target building of which energy consumption performance is to be evaluated; and an energy consumption performance evaluating operation of evaluating the energy consumption performance through benchmarking with consumption performance of another building by comparing the prediction value with the actual energy consumption amount calculated from energy consumption amount information of the target building.

The reference energy consumption amount predicting operation may predict a first energy consumption amount per annual unit area by calculating a building operation condition corresponding to an independent variable of the reference energy consumption amount prediction model from building plan information, building operation information, and energy consumption information of the target building, and by replacing the calculated building operation condition for the reference energy consumption amount prediction model regarding the building use of the target building.

The energy consumption performance evaluating operation may further include: a current energy consumption amount calculating operation of calculating the first energy consumption amount per annual unit area from actual energy consumption information of the target building; and an energy consumption performance analyzing operation of comparing a reference energy consumption amount predicted by the reference energy consumption amount predicting unit with an actual energy consumption amount calculated by the current energy consumption amount calculating unit, and comparing an energy consumption performance level of the target building with an energy consumption performance level of another building having a similar building use and operation condition and thereby evaluating the energy consumption performance of the target building. The evaluation performing operation may further include an evaluation performance result managing operation of displaying and managing the actual energy consumption amount, the reference energy consumption amount, and the comparison and evaluation.

According to exemplary embodiments of the present invention, an apparatus for evaluating energy consumption performance of a building may objectively evaluate energy consumption performance according to an operation scheme with respect to an existing building in operation, through benchmarking with consumption performance of a similar building.

Since a reference energy consumption amount used as a reference of evaluation may be calculated based on not previous performance but benchmarking, it is possible to more reasonably and accurately verify a potential energy saving amount of a building.

The present invention may be utilized as an evaluation tool for supporting a greenhouse gas/energy goal management system that is in effect led by the government in order to effectively save energy in an existing building. The present invention may also be utilized to plan a new authentication system of assigning a grade to energy consumption performance of a building in operation.

According to exemplary embodiments of the present invention, it is possible to benchmark actual energy performance of a building over the entire lifespan of the building, and to inspect whether the building is being operated as intended. Accordingly, it is possible to achieve a continuous energy saving effect in an operation and maintenance operation that consumes 80% or more among the entire costs required for the lifecycle of the building.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a block diagram to describe a configuration of an apparatus for evaluating energy consumption performance of a building according to an exemplary embodiment of the present invention.

FIG. 2 is a block diagram illustrating a detailed configuration of an evaluation managing unit that is one of major constituent elements of an apparatus for evaluating energy consumption performance of a building according to an exemplary embodiment of the present invention.

FIG. 3 is a diagram expressing data (that is, building plan information, building operation information, and energy consumption information) of standard buildings that are used to generate a reference energy consumption amount prediction model at an apparatus for evaluating energy consumption performance of a building according to an exemplary embodiment of the present invention.

FIG. 4 is a table illustrating an example of a standard building list classified for each building use and a reference energy consumption amount prediction model for each building use at an apparatus for evaluating energy consumption performance of a building according to an exemplary embodiment of the present invention.

FIG. 5 is a block diagram illustrating a detailed configuration of an evaluation performing unit that is one of major constituent elements of an apparatus for evaluating energy consumption performance of a building according to an exemplary embodiment of the present invention.

FIG. 6 is a flowchart illustrating a method of evaluating energy consumption performance of a building according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, exemplary embodiments of the present invention will be described in detail with reference to the accompanying drawings so as to be easily implemented by those skilled in the art. However, the present invention may be configured in various different types and thus, is not limited to the exemplary embodiments described herein. To clearly describe the present invention, a portion irrelevant to a description is omitted in the drawings and like reference numerals refer to like constituent elements throughout the present specification.

Throughout the present specification, when it is described that a predetermined portion “includes” a predetermined constituent element, it indicates that the predetermined portion may further include another constituent element instead of excluding the other constituent element unless differently described.

It should be noted that in assigning reference numerals to constituent elements in each drawing, like reference numerals are assigned to like constituent elements although they are illustrated in different drawings. When it is determined that the detailed description related to a related known function or configuration may make the purpose of the present invention unnecessarily ambiguous in describing the present invention, the detailed description will be omitted here.

In describing a constituent element of the present invention, a terminology such as “first”, “second”, A, B, (a), (b), and the like, may be used. The terminology is used to distinguish one constituent element from another constituent element and thus, essence, a sequence, an order, and the like, of a corresponding constituent element is not limited to the terminology. When it is described that a predetermined constituent element is “connected to”, “combined with”, or “accessed to” another constituent element, the predetermined constituent element may be directly connected to or accessed to the other constituent element, however, it should be understood that still another constituent element may be present between the predetermined constituent element and the other constituent element.

An amount of energy consumed in a building sector of Korea occupies about 24% of the entire energy consumption amount. With the enlargement of buildings and emphasis on user convenience, an energy consumption amount in the building sector is significantly increasing every year.

In order to save energy consumed in the building sector, there is a need to expand construction of a new building having high energy performance and at the same time, to continuously save energy in an existing building that is being currently operated.

Accordingly, to expand construction of a building having high energy performance and to efficiently manage energy of the building, a building energy efficiency grade system is in enforcement with respect to public housing and office buildings that are being newly built. The city of Seoul is also enforcing a building energy consumption quota system to verify a total energy consumption amount of a building in the case of applying architectural review and licensing with respect to a new building of at least a predetermined scale.

The city of Seoul is also aiming to implement the system by providing a building energy performance evaluating system, such as ECO2, a building energy simulation for Seoul (BESS), and the like, of measuring and evaluating energy performance based on plan data of a new building, and thereby calculating an energy performance grade on a plan.

On the contrary, in the case of an existing building in operation, a greenhouse gas/energy goal management system is being enforced only with respect to a building consuming at least a predetermined amount of energy. However, there is an issue in that the above system evaluates whether a goal is achieved by setting a saving goal using the average of energy consumption amounts based from the previous three years of a target building as a baseline (a reference consumption amount) and thus, is rather unfavorable to a building having been already operated in terms of energy saving or a building having relatively high energy consumption performance compared to other similar buildings.

To complement the aforementioned scheme of setting a reference consumption amount based on the previous performance, a method of setting a reference consumption amount based on benchmarking is prepared, but introduction thereof is being delayed due to un-development of an allocation coefficient.

Accordingly, to improve and activate the system with respect to an existing building, there is an urgent need for a more reasonable and objective baseline setting criterion.

To continue and maximize energy saving of an existing building in operation, there is a need to be capable of selecting a management target building based on a potential energy saving amount instead of using a simple energy consumption amount. Accordingly, to support this, a method capable of objectively evaluating a building energy consumption amount according to an operation scheme of a building is required.

Hereinafter, an apparatus for evaluating energy consumption performance of a building according to an exemplary embodiment of the present invention conceived to solve the aforementioned issues will be described with reference to the accompanying drawings.

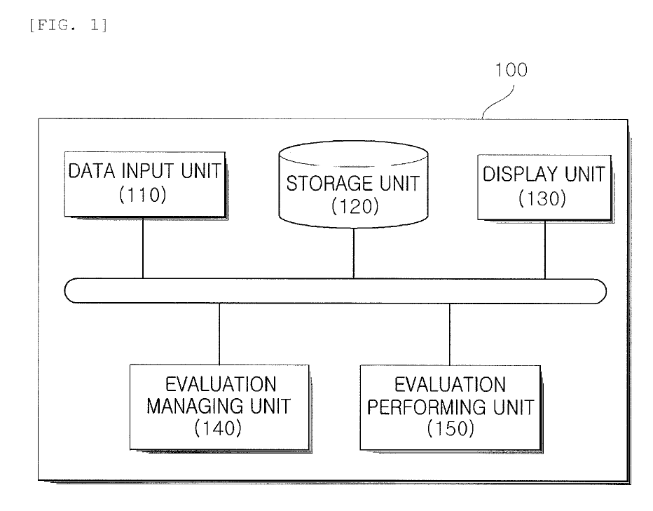

FIG. 1 is a block diagram to describe a configuration of an apparatus 100 for evaluating energy consumption performance of a building according to an exemplary embodiment of the present invention.

Referring to FIG. 1, the building energy consumption performance evaluating apparatus 100 generally includes a data input unit 110, a storage unit 120, a display unit 130, an evaluation managing unit 140, and an evaluation performing unit 150.

Describing in detail, initially, the data input unit 110 serves to receive, from a user, building plan information, building operation information, and energy consumption information about a plurality of buildings (B₁, B₂, . . . , Bₙ), and to transfer the building plan information, the building operation information, and the energy consumption information to the evaluation managing unit 140.

All of the input devices capable of inputting building plan information, building operation information, and energy consumption information about a building may be used as an input unit. Basically, for example, a keyboard of a computer, a touch pad, a mouse, a tablet, a scanner, a webcam, an optical mark reader (OMR), an optical character reader (OCR), a magnetic ink character reader, a barcode reader, and the like, may be used as the input unit.

The evaluation managing unit 140 serves to select a plurality of standard buildings using the building plan information, the building operation information, and the energy consumption information transferred from the data input unit 110, and to generate a reference energy consumption amount prediction model of predicting a first energy consumption amount (e₁, e₂, . . . , eₙ) per annual unit area from building plan information (p₁, p₂, . . . , pₙ) and building operation information (o₁, o₂, . . . , oₙ) of the standard buildings.

The evaluation performing unit 150 serves to determine a consumption performance level of an evaluation target building (Bₓ) by receiving building plan information (Pₓ), building operation information (Oₓ), and energy consumption information (Eₓ) of the target building (Bₓ) from the storage unit 120, by predicting a reference energy consumption amount of the evaluation target building (Bₓ) using a reference energy consumption amount prediction model, and by comparing the predicted reference energy consumption amount with an actual energy consumption amount calculated from input energy consumption amount information.

The storage unit 120 serves to store building plan information, building operation information, energy consumption information, standard building information, a reference energy consumption amount prediction model, and a comparison and evaluation result.

The display unit 130 serves to read an evaluation result of the evaluation performing unit 150 from the storage unit 120, and to provide the read evaluation result to the user.

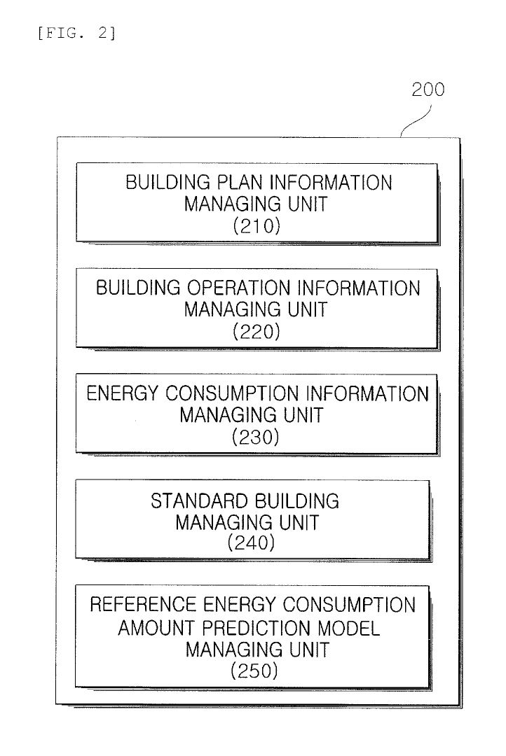

FIG. 2 is a block diagram illustrating a detailed configuration of an evaluation managing unit 200 that is one of major constituent elements of an apparatus for evaluating energy consumption performance of a building according to an exemplary embodiment of the present invention.

Referring to FIG. 2, the evaluation managing unit 200 may include a building plan information managing unit 210, a building operation information managing unit 220, an energy consumption information managing unit 230, a standard building managing unit 240, and a reference energy consumption amount prediction model managing unit 250.

Describing in detail, the building plan information managing unit 210 serves to receive, from the data input unit 110, building plan information including construction plan information, facility standard information, facility control scheme information, and the like, and to store the received building plan information in the storage unit 120.

Next, the building operation information managing unit 220 serves to receive building operation information in which an operation characteristic of a building is reflected, and to store the building operation information in the storage unit 120.

Meanwhile, the energy consumption information managing unit 230 serves to receive energy consumption information of the building that includes a monthly energy consumption amount based from at least previous one year, and to store the energy consumption information in the storage unit 120.

The standard building managing unit 240 serves to store a standard building list (B₁, B₂, B₃, . . . ) for each building use in the storage unit 120 by classifying buildings into an office, a commerce, a school, a hospital, a data center, a hotel, a large mart, a garage, and the like, based on a main use of a building, using building plan information, building operation information, and energy consumption information stored in the storage unit 120, and by selecting a plurality of standard buildings to be suitable for a standard building selection criterion for each building use.

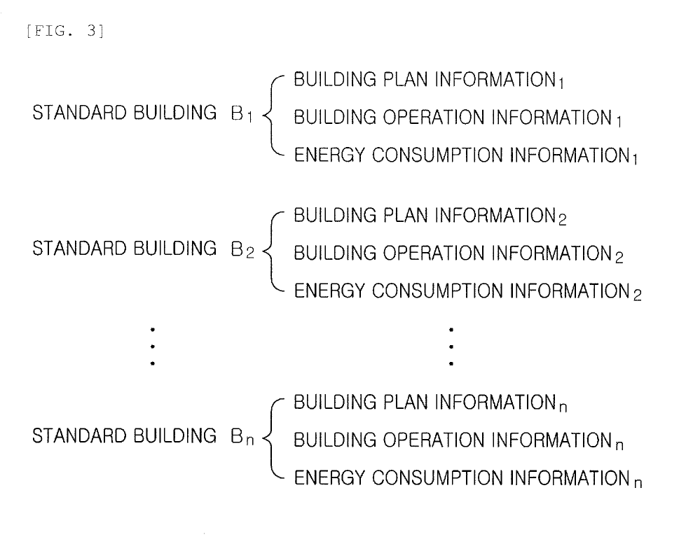

Here, for reference, initially referring to FIG. 3, FIG. 3 is a diagram expressing data (that is, building plan information, building operation information, and energy consumption information) of standard buildings that are used to generate a reference energy consumption amount prediction model at an apparatus for evaluating energy consumption performance of a building.

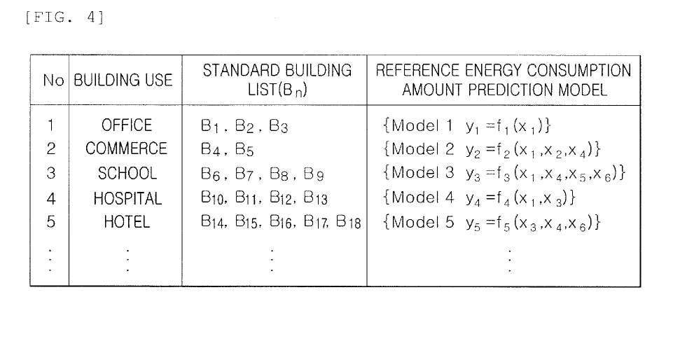

Referring to FIG. 3, it can be known that each of the standard buildings (B₁, B₂, B₃, . . . ) includes values of building plan information, building operation information, and energy consumption information. A reference energy consumption amount prediction model may be generated using such attribute values, which may be expressed by a table of FIG. 4.

FIG. 4 is a table illustrating an example of a standard building list classified for each building use and a reference energy consumption amount prediction model for each building use at an apparatus for evaluating energy consumption performance of a building according to an exemplary embodiment of the present invention.

Referring to FIG. 4, it can be known that at least one building is selected as a standard building, and an energy consumption amount is predicted from building plan information and building operation information of the standard building.

That is, a standard building list (Bₙ) for each building use is generated by classifying a plurality of buildings based on a building use (ex., office, commerce, school, hospital, hotel, and the like), and by selecting a standard building from the classified buildings based on the building use.

A reference energy consumption amount prediction model exemplified on the rightmost column of the table arranged for each building use may be defined as an equation model of energy consumption amount prediction that includes, as an independent variable (x₁, x₂, x₃, . . . ) from building plan information and building operation information of a building belonging to the standard building list (Bₙ), a building operation condition having a high correlation with an actual energy consumption amount of the building in operation, and includes, as a dependent variable (y₁, y₂, y₃, . . . ) from energy consumption information of the building, a value obtained by calculating a first energy consumption amount per annual unit area.

The reference energy consumption amount prediction model is not limited to the model exemplified herein. All of the equation models in which a prediction value of an energy consumption amount varies based on a building operation condition may be included in the reference energy consumption amount prediction model.

Referring again to FIG. 2, the reference energy consumption amount prediction model managing unit 250 that is a final constituent element included in the evaluation managing unit 200 serves to generate a reference energy consumption amount prediction model of predicting an energy consumption amount from the stored building plan information and building operation information of the standard building for each building use, and to store the reference energy consumption amount prediction model in the storage unit 120.

The evaluation managing unit 200 constructed as above induces a coefficient of the reference energy consumption amount prediction model using building plan information, building operation information, and energy consumption information of a reference building, and generates at least one reference energy consumption amount prediction model for each building use.

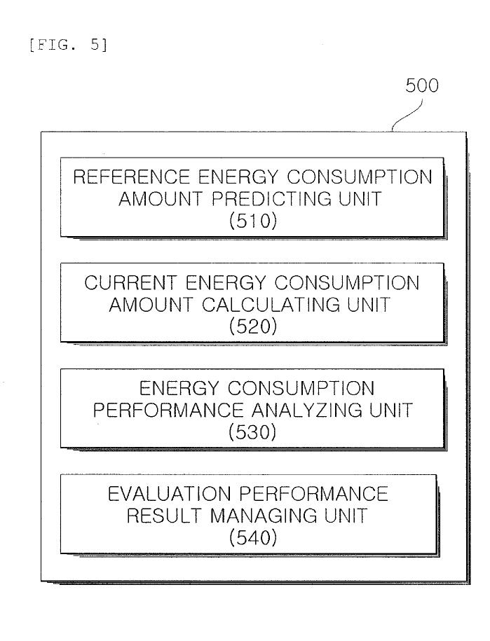

FIG. 5 is a block diagram illustrating a detailed configuration of an evaluation performing unit 500 that is one of major constituent elements of an apparatus for evaluating energy consumption performance of a building according to an exemplary embodiment of the present invention.

Referring to FIG. 5, the evaluation performing unit 500 serves to calculate a prediction value of a reference energy consumption amount using the reference energy consumption amount prediction model, based on a building operation condition of the evaluation target building of which energy consumption performance is to be evaluated, and to evaluate the energy consumption performance through benchmarking with consumption performance of another building by comparing the prediction value with an actual energy consumption amount calculated from energy consumption amount information.

To this end, the evaluation performing unit 500 may further include a reference energy consumption amount predicting unit 510. The reference energy consumption amount predicting unit 510 serves to predict a first energy consumption amount per annual unit area by reading building plan information and building operation information of the evaluation target building (Bₓ) stored in the storage unit 120 and thereby calculating an operation condition corresponding to an independent variable of the reference energy consumption amount prediction model from the read building plan information and building operation information, and by reading the reference energy consumption amount prediction model regarding the building use of the evaluation target building from the storage unit 120 and thereby replacing the calculated operation condition for the reference energy consumption amount prediction model.

For comparison and evaluation, the evaluation performing unit 500 may further include a current energy consumption amount calculating unit 520 configured to read actual energy consumption amount information of the evaluation target building stored in the storage unit 120 and to calculate a first energy consumption amount per annual unit area from the read actual energy consumption amount information.

The evaluation performing unit 500 may further include an energy consumption performance analyzing unit 530 configured to evaluate whether an energy consumption performance level of the evaluation target building is higher or lower than a level of a similar building having the same main building use and similar operation condition by comparing the aforementioned predicted reference energy consumption amount with the calculated actual energy consumption amount.

The evaluation performing unit 500 may further include an evaluation performance result managing unit 540 configured to store the predicted reference energy consumption amount, the actual energy consumption amount, and an analysis result in the storage unit 120.

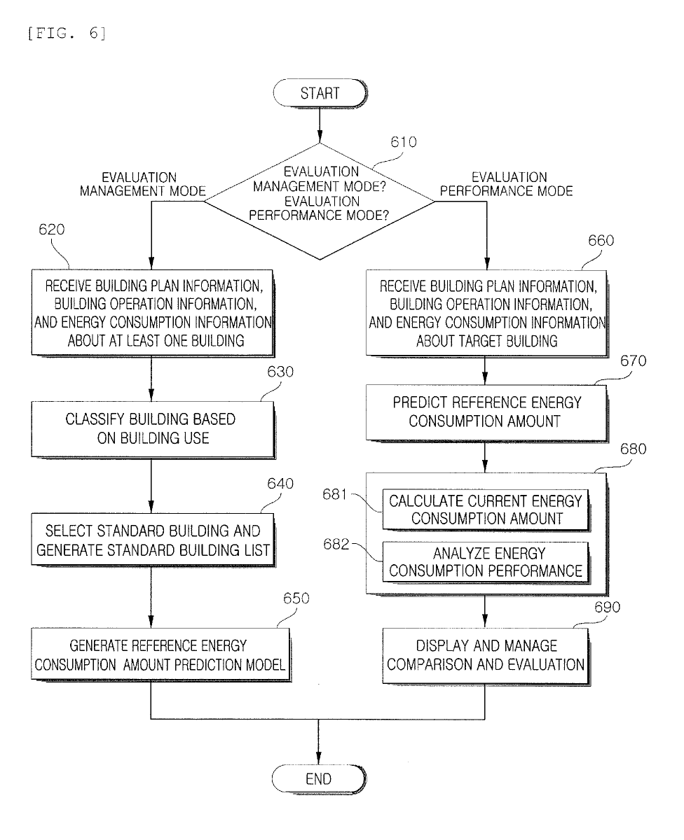

FIG. 6 is a flowchart illustrating a method of evaluating energy consumption performance of a building according to an exemplary embodiment of the present invention.

Referring to FIG. 6, to evaluate energy consumption performance of a building according to the present invention, the method of evaluating energy consumption of the building may be divided into and thereby proceed with an evaluation management mode (operation 620) of generating an equation model of predicting a reference energy consumption amount used as a criterion of evaluation from a standard building and an evaluation performance mode (operation 660) of evaluating energy consumption performance of an actual evaluation target building.

In general, in operation 610, the evaluation management mode (operation 620) is selected and a reference energy consumption amount prediction evaluating model for each building use is generated. Next, the evaluation performance mode (operation 660) is selected and evaluation for the target building is performed.

More specifically describing, initially, when the evaluation management mode is selected, building plan information, building operation information, and energy consumption information about at least one building is received from a user through the data input unit 110 and is stored in the storage unit 120 (operation S620). At least one building is classified into an office, a commerce, a school, a hospital, a data center, a hotel, a large mart, a garage, and the like, based on a main use of a building using the stored building plan information, building operation information, and energy consumption information (operation 630).

Next, a standard building list for each building use is generated by selecting a plurality of standard buildings to be suitable for a standard building selection criterion for each building use and stored in the storage unit 120 (operation 640).

When an operation of generating a reference energy consumption amount prediction model of predicting an energy consumption amount from the stored building plan information and building operation information of the standard building for each building use and storing the generated reference energy consumption amount prediction model in the storage unit 120 (operation 650) is terminated, the evaluation management mode is terminated.

Meanwhile, when the evaluation performance mode is selected in operation 610, building plan information, building operation information, and energy consumption information about a target building desired to be evaluated are received from the user (operation 660).

Next, a reference energy consumption amount of the evaluation target building is predicted by reading the reference energy consumption amount prediction model regarding a building use of the evaluation target building from the storage unit 120 (operation 670).

That is, a reference energy consumption amount may be predicted by predicting a first energy consumption amount per annual unit area by reading building plan information and building operation information of the evaluation target building (Bₓ) stored in the storage unit 120 and thereby calculating an operation condition corresponding to an independent variable of the reference energy consumption amount prediction model from the read building plan information and building operation information, and by reading the reference energy consumption amount prediction model regarding the building use of the evaluation target building from the storage unit 120 and thereby replacing the calculated building operation condition for the reference energy consumption amount prediction model.

When entering into a subsequent operation of performing comparison and evaluation (operation 680), a current energy consumption amount calculating operation (operation 681) of reading actual energy consumption amount information of the evaluation target building stored in the storage unit 120 and calculating the first energy consumption amount per annual unit area from the read actual energy consumption amount information is performed.

An energy consumption performance analyzing operation of evaluating whether an energy consumption performance level of the evaluation target building is higher or lower than a level of a similar building having the same main building use and similar operation condition by comparing the aforementioned predicted reference energy consumption amount with the calculated actual energy consumption amount (operation 682) is performed.

Finally, an evaluation performance result is stored in the storage unit 120 and is provided to the user through the display unit 130.

According to the present invention, an apparatus for evaluating energy consumption performance of a building may objectively evaluate energy consumption performance according to an operation scheme with respect to an already built building in operation, through benchmarking with consumption performance of a similar building. Since a reference energy consumption amount used as a reference of evaluation may be calculated based on not previous performance but benchmark, it is possible to more reasonably and accurately verify a potential energy saving amount of a building. The present invention may be utilized as an evaluation tool for supporting a greenhouse gas/energy goal management system that is in effect led by the government in order to effectively save energy in an existing building. The present invention may also be utilized to plan a new authentication system of assigning a grade to energy consumption performance of a building in operation. According to the present invention, it is possible to benchmark actual energy performance of a building over the entire lifespan of the building, and to inspect whether the building is being operated as intended. Accordingly, it is possible to achieve a continuous energy saving effect in an operation and maintenance operation that consumes most of the entire costs required for the lifecycle of the building.

All of the constituent elements configuring the exemplary embodiments of the present invention are described to be combined into one or to be combined and thereby be operated, but the present invention is not limited to the exemplary embodiments. That is, without departing from the scope of the present invention, all of the constituent elements may be selectively combined into at least one and thereby be operated. Although each of all of the constituent elements is configured as single independent hardware, a portion of or all of the constituent elements may be selectively combined and thereby configured as a computer program having a program model that performs a portion of or all of the functions combined in single or a plurality of hardware. Such computer program may be stored in computer-readable media such as a USB memory, a CD disk, a flash memory, and the like, and be read and executed by a computer, thereby embodying the exemplary embodiments of the present invention. Storage media of the computer program may include magnetic storage media, optical storage media, carrier wave media, and the like.

The terminology “includes (comprises)”, “configures”, “has”, and the like described above may indicate that a corresponding constituent element may be embedded unless particularly differently described and thus, should be interpreted that another constituent element may be further included instead of excluding the other constituent element. Unless differently defined in the detailed description, all of the terminologies including a technical terminology or a scientific terminology have the same meaning as a meaning generally understood by those skilled in the art. Generally used terminologies, such as a terminology defined in a dictionary, should be interpreted to match the contextual meaning of the related art and should not be interpreted as an idealistic or excessively formal meaning unless clearly defined in the present invention.

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. An apparatus for evaluating energy consumption performance of a building, the apparatus comprising:
a data input unit configured to receive building plan information, building operation information, and energy consumption information about at least one building;
an evaluation managing unit configured to generate a reference energy consumption amount prediction model regarding the building based on the building plan information, the building operation information, and the energy consumption information that are transferred from the data input unit;
an evaluation performing unit configured to determine energy consumption performance of a target building based on a comparison result with an actual energy consumption amount based on the reference energy consumption amount prediction model, using building plan information, building operation information, and energy consumption information about the target building of which energy consumption performance is to be evaluated;
a storage unit configured to store an evaluation result in which the building plan information, the building operation information, the energy consumption information, the reference energy consumption amount prediction model, and the energy consumption performance are determined; and
a display unit configured to provide the stored evaluation result to a user.

2. The apparatus of claim 1, wherein the evaluation managing unit selects the at least one building as a standard building and predicts an energy consumption amount from building plan information and building operation information of the standard building.

3. The apparatus of claim 2, wherein the evaluation managing unit further comprises:
a standard building managing unit configured to classify the at least one building based on a building use, and to generate and manage a standard building list for each building use by selecting the standard building from the classified buildings based on the building use.

4. The apparatus of claim 3, wherein the evaluation managing unit further comprises:
a reference energy consumption amount prediction model managing unit configured to generate and manage the reference energy consumption amount prediction model, and
the reference energy consumption amount prediction model is defined as an equation model of energy consumption amount prediction that includes, as an independent variable from building plan information and building operation information of a building belonging to the standard building list, a building operation condition having a high correlation with an actual energy consumption amount of a building in operation, and includes, as a dependent variable from energy consumption information of the building, a value obtained by calculating a first energy consumption amount per annual unit area.

5. The apparatus of claim 4, wherein the evaluation managing unit induces a coefficient of the reference energy consumption amount prediction model using building plan information, building operation information, and energy consumption information of the building belonging to the standard building list, and generates at least one reference energy consumption amount prediction model for each building use based on the building use.

6. The apparatus of claim 5, wherein the evaluation managing unit further comprises:
a building plan information managing unit configured to manage at least one of construction plan information, facility standard information, and facility control scheme information as the building plan information;
a building operation information managing unit configured to manage building operation information in which an operation characteristic of the building is reflected; and
an energy consumption information managing unit configured to manage energy consumption information that includes a monthly energy consumption amount based from at least previous one year.

7. The apparatus of claim 1, wherein the evaluation performing unit calculates a prediction value of a reference energy consumption amount using the reference energy consumption amount prediction model, based on a building operation condition of the target building of which energy consumption performance is to be evaluated, and evaluates the energy consumption performance through benchmarking with consumption performance of another building by comparing the prediction value with the actual energy consumption amount calculated from energy consumption amount information.

8. The apparatus of claim 7, wherein the evaluation performing unit further comprises:
a reference energy consumption amount predicting unit configured to predict a first energy consumption amount per annual unit area by calculating a building operation condition corresponding to an independent variable of the reference energy consumption amount prediction model from building plan information, building operation information, and energy consumption information of the target building, and by replacing the calculated building operation condition for the reference energy consumption amount prediction model regarding the building use of the target building.

9. The apparatus of claim 8, wherein the evaluation performing unit further comprises:
a current energy consumption amount calculating unit configured to calculate the first energy consumption amount per annual unit area from actual energy consumption information of the target building;
an energy consumption performance analyzing unit configured to compare a reference energy consumption amount predicted by the reference energy consumption amount predicting unit with an actual energy consumption amount calculated by the current energy consumption amount calculating unit, and to compare an energy consumption performance level of the target building with an energy consumption performance level of another building having a similar building use and operation condition and thereby evaluate the energy consumption performance of the target building; and
an evaluation performance result managing unit configured to manage the actual energy consumption amount, the reference energy consumption amount, and the comparison and evaluation.

10. A method of evaluating energy consumption performance of a building, the method comprising:
a data input operation of receiving building plan information, building operation information, and energy consumption information about at least one building;
an evaluation managing operation of generating a reference energy consumption amount prediction model regarding the building based on the building plan information, the building operation information, and the energy consumption information that are transferred in the data input operation;
an evaluation performing operation of determining energy consumption performance of a target building based on a comparison result with an actual energy consumption amount based on the reference energy consumption amount prediction model, using building plan information, building operation information, and energy consumption information about the target building of which energy consumption performance is to be evaluated;
a storage operation of storing an evaluation result in which the building plan information, the building operation information, the energy consumption information, the reference energy consumption amount prediction model, and the energy consumption performance are determined; and
a display operation of providing the stored evaluation result to a user.

11. The method of claim 10, wherein the evaluation managing operation further comprises:
a classifying operation of classifying the at least one building based on a building use; and
a standard building managing operation of generating and managing a standard building list for each building use by selecting a standard building from the classified buildings based on the building use.

12. The method of claim 11, wherein the evaluation managing operation further comprises:
a reference energy consumption amount prediction model managing operation of generating and managing the reference energy consumption amount prediction model, and
the reference energy consumption amount prediction model is defined as an equation model of energy consumption amount prediction that includes, as an independent variable from building plan information and building operation information of the building belonging to the standard building list, a building operation condition having a high correlation with an actual energy consumption amount of a building in operation, and includes, as a dependent variable from energy consumption information of the building, a value obtained by calculating a first energy consumption amount per annual unit area.

13. The method of claim 12, wherein the evaluation performing operation further comprises:
a reference energy consumption amount predicting operation of calculating a prediction value of a reference energy consumption amount using the reference energy consumption amount prediction model based on a building operation condition of the target building of which energy consumption performance is to be evaluated; and
an energy consumption performance evaluating operation of evaluating the energy consumption performance through benchmarking with consumption performance of another building by comparing the prediction value with the actual energy consumption amount calculated from energy consumption amount information of the target building.

14. The method of claim 13, wherein the reference energy consumption amount predicting operation predicts a first energy consumption amount per annual unit area by calculating a building operation condition corresponding to an independent variable of the reference energy consumption amount prediction model from building plan information, building operation information, and energy consumption information of the target building, and by replacing the calculated building operation condition for the reference energy consumption amount prediction model regarding the building use of the target building.

15. The method of claim 14, wherein
the energy consumption performance evaluating operation further comprises:
a current energy consumption amount calculating operation of calculating the first energy consumption amount per annual unit area from actual energy consumption information of the target building; and
an energy consumption performance analyzing operation of comparing a reference energy consumption amount predicted by the reference energy consumption amount predicting unit with an actual energy consumption amount calculated by the current energy consumption amount calculating unit, and comparing an energy consumption performance level of the target building with an energy consumption performance level of another building having a similar building use and operation condition and thereby evaluating the energy consumption performance of the target building, and
the evaluation performing operation further comprises:
an evaluation performance result managing operation of displaying and managing the actual energy consumption amount, the reference energy consumption amount, and the comparison and evaluation.
